(19) United States
(12) Patent Application Publication
(10) Pub. No.: US 2004/0140637 A1
(43) Pub. Date: Jul. 22, 2004

(54) Ski vehicle emergency ski brake system

(76) Inventors: Travis Cook, Prairie, ID (US); Joseph Putney, Caldwell, ID (US)

Correspondence Address: PEDERSEN & COMPANY, PLLC, P.O. BOX 2666, BOISE, ID, 83701, US

(21) Appl. No.: 10/685,998

(22) Filed: Oct. 14, 2003

Related U.S. Application Data
(60) Provisional application No. 60/418,046, filed on Oct. 11, 2002.

(51) Int. Cl. B62B 9/04

(52) U.S. Cl. 280/28.11

(57) ABSTRACT

An emergency ski brake system located above and to the side and acting in the close vicinity of the pivot point of the runner of a ski vehicle. The preferred embodiment has one or more protruding braking members on each ski that when released by a latching mechanism, rotate forward helically around the outside edge of the runner to substantially engage the terrain more so than does the bottom surface of the runner. The protruding member may take the form of a blade or spike, prong or other single, plural, smooth or toothed members that extend around and under the ski to stab 1-6 inches into the terrain provided that the mechanism and attached protruding member is located alongside and perpendicular to the pivot point of the runner and actuates in a forward, helical rotation in relation to the direction of the runner. There may also be included a safety tether or other operator absence detecting mechanism located on the ski vehicle which actuates the emergency ski brake system in case of accidental operator dismount.

### BACKGROUND OF THE INVENTION

1. Field of the Invention

This invention relates, in general, to snowmobile and other ski vehicle emergency ski brake systems. More specifically, the invention relates to emergency ski brake systems that improve control of the vehicle's forward or backward motion during an emergency, even when the conventional braking method, that is, slowing or stopping the drive track for snowmobiles, for example, fails to adequately control the vehicle.

2. Related Art

Snowmobiles, for example, are conventionally slowed or stopped in an emergency by slowing or stopping the drive track, that is, the endless belt that moves against the terrain to power the snowmobile. Because the drive track causes the snowmobile's movement relative to the ground, the drive track is conventionally used to achieve slower movement or to stop the movement of the snowmobile. Using this as the sole braking method during an emergency, however, can be ineffective and even dangerous in conditions in which the drive track's frictional contact with the terrain is not optimum or when the vehicle's weight is concentrated on the runners and not on the drive track. For example, when the drive track is clogged with snow, engagement of the track with the terrain on the snowmobile's course is not always sufficient to quickly slow or stop the snowmobile in order to regain control. Or, when the snowmobile is traveling downhill, the track tends not to grip the terrain adequately or quickly enough when used because the rider's weight is concentrated over the skis, not the track. Under these conditions, therefore, the track tends to slip rather than grip the terrain, thus the conventional emergency braking system is inadequate. Another attempt at solving this problem is the wrapping of a belt or chain around the ski before descending a hill. This solution is inadequate in that while it does provide downhill speed control, it dramatically reduces the ability of the operator to control the vehicle because the belts or chains stop the movement of snow under the skis and become a hindrance to the turning effectiveness of the ski. This method also is only effective if the operator has time to wrap these devices around the skis before a descent and will not work if the operator falls of the vehicle.

One attempt at a solution to the ski braking problem has been posed in the patent literature, as shown in U.S. Pat. No. 5,673,722 (Martin, Oct. 7, 1997). Martin discloses a ski-type runner system, which includes a downwardly extendable flap at the rear end of each runner that may be actuated to drag in the snow. Martin teaches that the two flaps are actuated in unison so that balanced braking force is applied to each trailing ski end on both sides of the snowmobile. It is understood, however, that the rearward flap of Martin is inadequately located to take maximum advantage of the weight of the vehicle and may adversely affect the handling characteristics of the snowmobile during operation.

Another attempt at a solution to this braking problem is shown in U.S. Pat. No. 5,931,481 (Hoffman, Aug. 3, 1999). Hoffman discloses a snowmobile braking system with two (2) blades, which are downwardly extendable from each side of the central portion of a ski. However, only one of the snowmobile's two skis is equipped with the braking system. It is expected that the single-ski brake of Hoffman is inadequate in an emergency situation as it will cause loss of control of the ski vehicle due to uneven braking force.

Still, an effective and safe ski vehicle emergency ski brake system is needed to improve handling and regain control in icy or downhill condition, for example. Such an emergency ski brake system is needed that does not depreciate from or interfere with handling, but rather add to the control of, the ski vehicle should an emergency occur.

### SUMMARY OF THE INVENTION

The present invention comprises an emergency ski brake system with one or more ski brake mechanisms that are located along side of the perpendicular to (in relation to the runners' direction of travel) the spindle attached to the runner, and actuate in a forward, helical rotation in relation to the direction of the runner on a ski vehicle, for example, a snowmobile.

On a conventional snowmobile, the steering pivot point is near the middle of the longitudinal axis of the runner, and, hence, the preferred braking member rotates from beside the pivot point and around the outside edge of the runner in a forward helical radius to place the braking member in contact with the terrain. This causes the protruding braking member to “catch” the terrain and rotate rearward and under the runner to contact the side and bottom surface of the runner in a quick, simultaneous motion. Because the helically rotating member simultaneously contacts both the bottom and the side of the runner when applied, the existing strength of the ski is utilized to “share” the tremendous stress placed on the braking mechanism during use. This “sharing” of the load allows the emergency ski brake mechanism to be made of inexpensive yet lightweight materials, of which whose use in construction are essential to the satisfactory performance of a ski vehicle, namely, a snowmobile. The preferred embodiment comprises a brake mechanism on each runner, each of which incorporate a spring loaded braking member which is designed to be deliberately released by mechanical, electrical, pneumatic or other means solely by the operator and is intended to be reset to a non-interfering position by manual, automatic or other means after use.

Also, the position of the blades on the helically rotating member, when placed on the outside of each runner, act not only to slow or stop the ski vehicle, they act to “pivot” the vehicle during a turn. For example; the camber, which is incorporated into the steering geometry of the vehicle, forces the inside blade, that is, the blade closest to the center of the radius of an intended turn, to further engage the terrain while at the same time lifting the outside blade, that is, the blade furthest from the center of a turning radius, out of the terrain. This causes the vehicle to “pivot” around the inside braking member. This effect is understood to greatly enhance the downhill steering control of the ski vehicle.

Optionally, there may be included a safety tether attached to the rider, or other operator absence detecting mechanism located on the ski vehicle, which can actuate the emergency ski brake system in case of accidental operator dismount. This mechanism would effectively slow or stop the vehicle if the operator and the vehicle become separated.

The preferred invention utilizes a brake on each runner of the ski vehicle using simultaneous actuation of each brake unit to maximize operator control by providing balanced braking force. This eliminates the tendency to cause the vehicle to swerve unexpectedly and therefore cause loss of control and possible damage or harm.

### BRIEF DESCRIPTION OF THE DRAWINGS

FIG. 1 is a schematic side view of one embodiment of the invention with the blade of the brake in the “go” position.

FIG. 2 is a schematic side view of the embodiment depicted in FIG. 1 with the blade of the brake rotated in the “stop” position.

FIG. 3 is a schematic front cutaway view of one embodiment of the brake with the blade in the “go” position.

FIG. 4 is a schematic front cutaway view of one embodiment of the brake with the blade in the “stop” position.

FIG. 5 is a schematic top view of the brake showing the angle of engagement of the helically rotating member and blade with the terrain in one embodiment of the invention.

FIG. 6 is a perspective view of the entire emergency ski brake assembly of one embodiment of the invention.

FIG. 7 is an exploded view of the emergency braking mechanism showing a schematic of the ski brake mechanism and it's attaching members.

### DESCRIPTION OF THE PREFERRED EMBODIMENTS

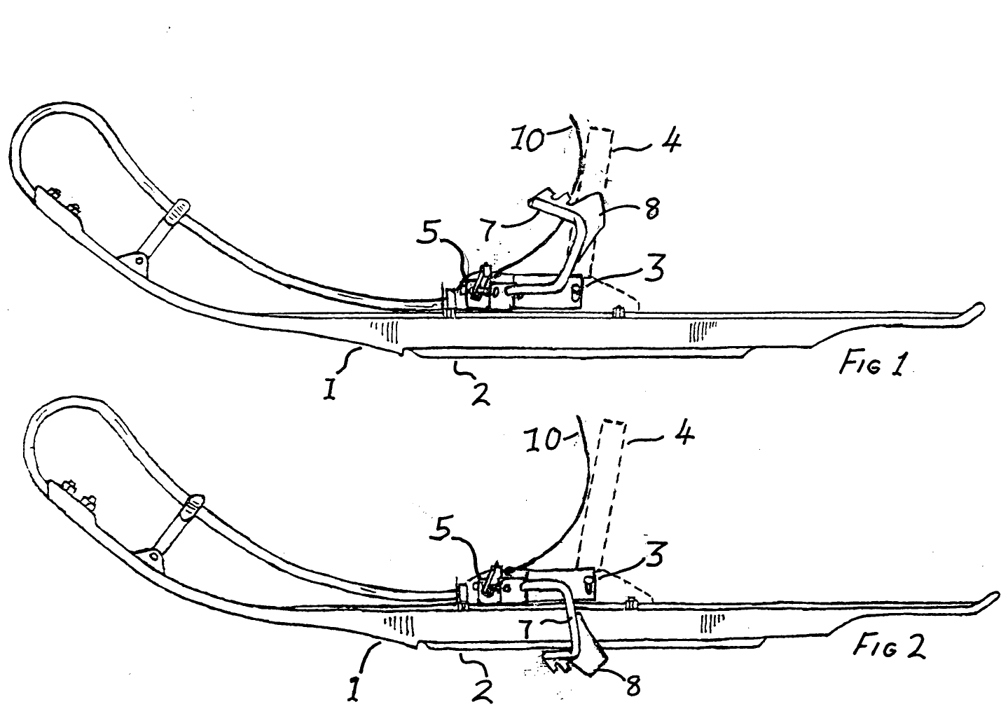

Referring to the figures, there is shown one, but not the only, embodiment of the invented ski vehicle emergency ski brake system. FIG. 1 shows the blade of the brake in the “go” position. FIG. 2 shows the blade of the brake in the “stop” position.

In FIGS. 1 and 2 is depicted a schematic side view of one embodiment of the emergency ski brake mechanism. A ski runner is attached to a suspension spindle of a ski vehicle, for example, a snowmobile (not shown). The attachment point of runner to spindle is generally about mid-way between front end and rear end of the runner.

The emergency ski brake system as shown in FIG. 1-7 includes securing bracket (5), helically rotating member (7) and blade (8), and control lever (9) with control cable (10). Control lever (9) is actuated by operator, (not shown) which then, by way of control cable (10) activates the ski braking mechanism. This action then releases helically rotating member (7) and blade (8) which travel in a forward, helical arc around and under runner (1) to contact the terrain and thus relax the spring tension contained by torsion spring (12). When blade (8) attached to helically rotating member (7) contacts the surface of the terrain, the angle of rearward and upward sloping blade acts to pull itself into the snow/ground and begin a rearward, helical rotation to contact the side of runner (1) and bottom edge of wear bar (2) into what is the “stop” position. The position of blade (8) and helically rotating member (7) held in place by the passing terrain causes them to remain in that position until the ski vehicle has stopped and the ski brake is manually reset to the “go” position. Thus, helically rotating member (7) and blade (8) tend to “share the load” acting on the brake with the runner (1) by prying against it and thus allowing the brake to be constructed of lightweight, inexpensive materials.

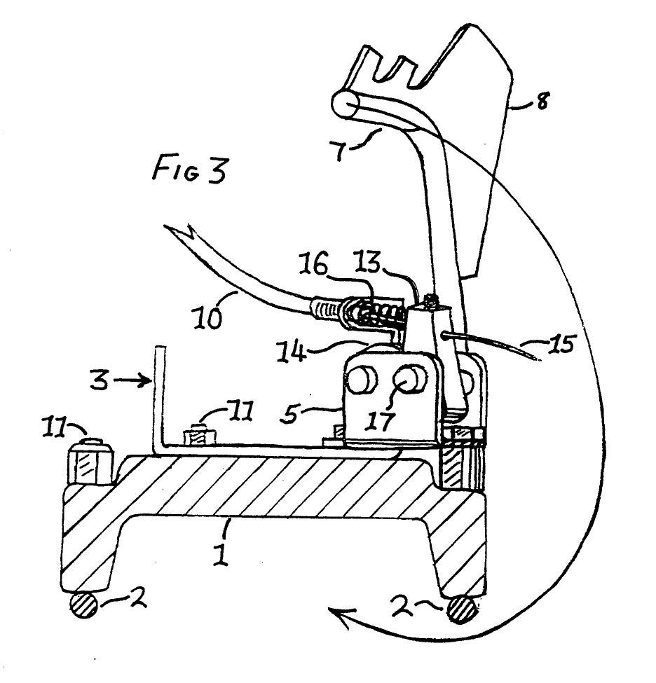

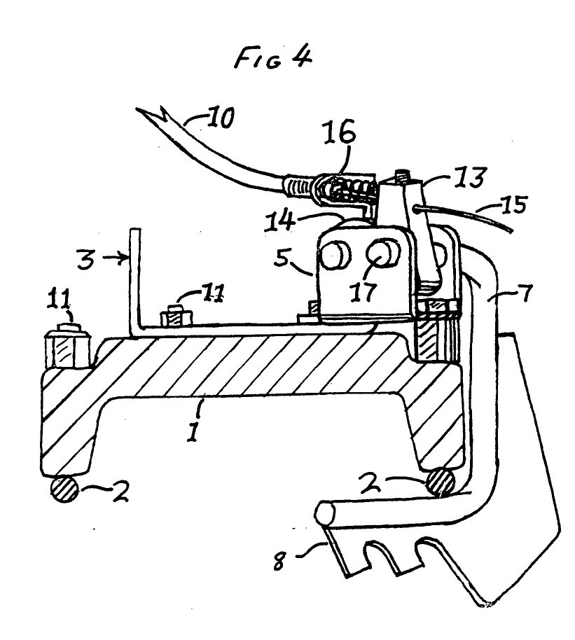

In FIG. 3 is shown a schematic forward facing cutaway view of one embodiment of the invention. When blade (8) and helically rotating member (7) are in the “go” position, blade (8) and helically rotating member (7) are manually locked in place somewhat above and to the side of spindle pivot point (3) In this way, blade (8) and helically rotating member (7) are non-obstructing and thus do not interfere with the normal operation of the ski vehicle when the brakes are not needed.

In FIG. 4 is shown a schematic top view of one embodiment of the invention. Securing bracket (5) is attached to runner (1) by means of existent fasteners (11). Directly pivoting from securing bracket (5) is helically rotating member (7) and blade (8) which rests in the “go” position parallel to the direction of the runner (1) to the side spindle pivot point (3).

A preferred feature, for example, is the slightly rearward facing angle at which blade (8) rests in the “stop” position in reference to the direction of the runner (1). This almost-perpendicular angle allows for “cleaning” of blade (8), that is, the sideways directing of the aggravated snow/ground, but not so much angle as to allow blade (8) to affect the direction of the ski vehicle during operation should one of the two envisioned ski brakes lose contact with the terrain. During normal operation, both brakes would act in unison with each other thus allowing the feel of the ski vehicle to remain neutral. Likewise, the location of the blades (8) attached to the helically rotating members (7) to the outside of each runner( 1) combined with the leaning action caused by the camber of the spindles (4) of the ski vehicle when during a turn would cause the helically rotating members (7) and blades (8) to act to “pivot” the vehicle and therefore enhance control when turning.

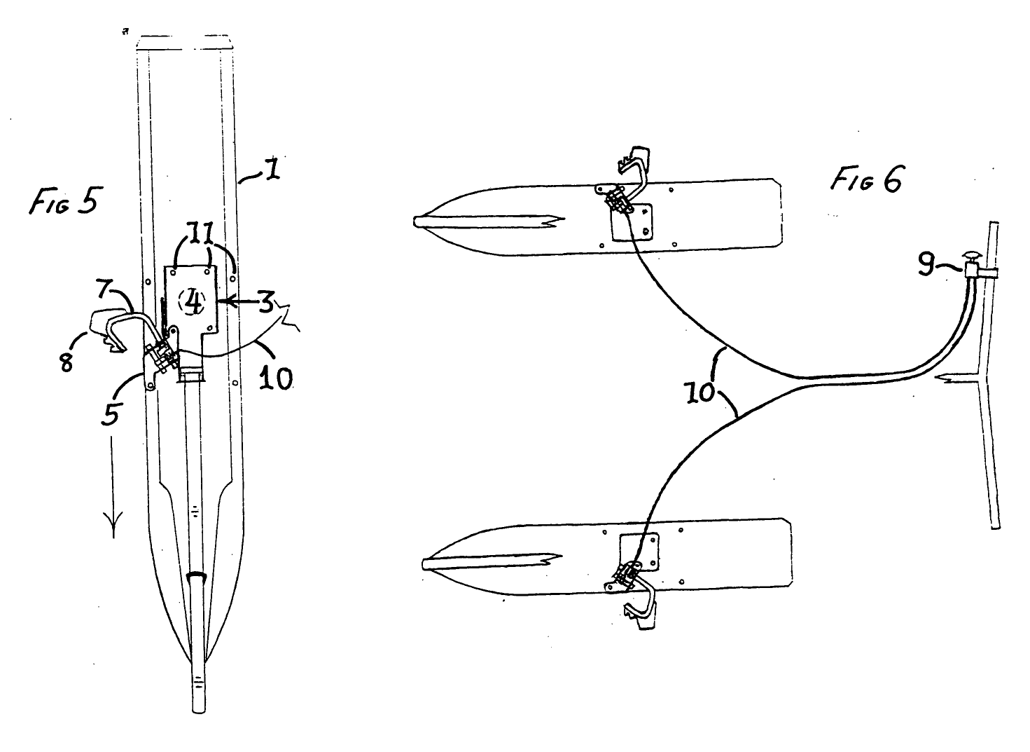

In FIG. 5 is shown a schematic view of one of the entire emergency ski brakes of one embodiment of the invention attached to runner (1) showing position of spindle(4), helically rotating member (7), and blade (8).

In FIG. 6 is a schematic of the entire emergency ski brake assembly. Both ski brakes are simultaneously controlled by the joining of control cable (10) from each brake and therefore ultimately activated by a single control lever (9). In this way, safety can be maintained through balanced braking force so as not to cause swerving when the emergency ski brake system has been activated.

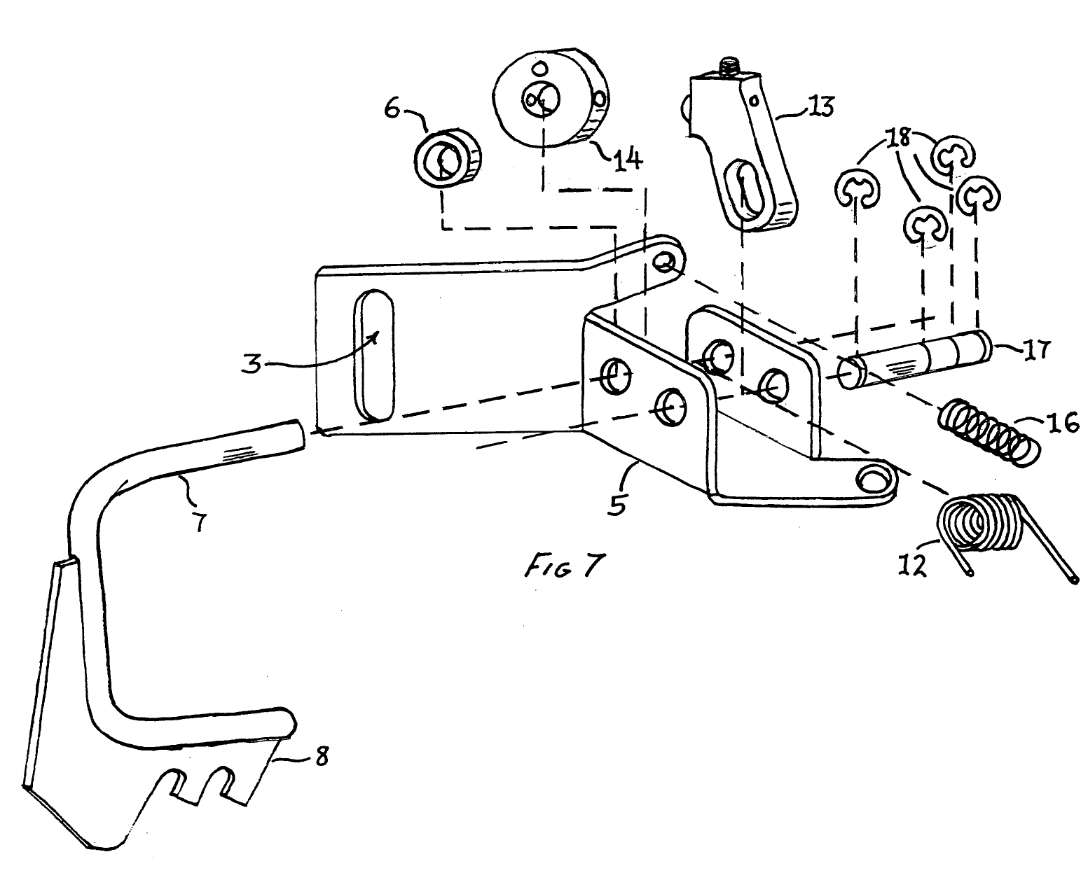

In FIG. 7 is shown as exploded view depicting in detail the individual parts of one of the ski brake mechanisms and attaching members thereof in one embodiment of the invention. Attacked to the runner (1) by means of existing fasteners (11) is securing bracket (5) which supports helically rotating member (7) and trigger (13). Securing bracket (5) also serves to protect the entire mechanism from debris while remaining open to the rear to enable proper function. Locked on to the shaft of helically rotating member (7) is trigger collar (14) and torsion spring (12). Mounted on trigger pin (17) is trigger (13) held in place by e-clips (18). Trigger (13) retains force of torsion spring (12) by acting upon the trigger collar (14) when in the “go” position. When trigger (13) is released by control cable end (15) and trigger spring (16), the retained rotational force of torsion spring (12) acting upon trigger collar (14) which is retained in the “go” position by trigger (13) allows trigger collar (14) to slip by trigger (13) and place helically rotating member and blade (8) into the passing terrain and into the “stop” position. Control lever (9) must then by reset and the helically rotating member (7) rotated back into the “go” position before normal vehicle operation can resume.

The inventors also envision that a safety tether release system may also be added, to immediately activate the emergency ski brake system into the stop position when, for example, the operator leaves his/her riding position or is separated from the vehicle.

Another preferred embodiment of the disclosed invention is the manufacturing process by which the emergency ski brake system is made and produced. The preferred embodiment of the invention is designed in such a way that most of the parts are made left/right interchangeable to aid in manufacturing and cost and to allow part serviceability. Initial assembly determines which side each part is applicable to but it is to be understood that most parts can be interchanged from left to right.

Although this invention has been described above with reference to particular means, materials or embodiments, it is to be understood that the invention herein described is not limited to these disclosed particulars, but extends instead to all equivalents within the scope of the following claims.

I claim:

1. A ski vehicle emergency ski brake system comprising; a first unit on a first runner and a second unit on a second runner, the first unit and second unit both comprising a helically rotating member and blade to be activated by a spring loaded trigger mechanism, a single control system to simultaneously activate all units, and a control lever and control cable for means of intentional simultaneous actuation.

2. An emergency ski brake system as in claim 1 wherein the first ski runner has a pivot point for receiving a snowmobile suspension and steering mechanism, and wherein the first unit is located along side of and perpendicular to the suspension spindle and above said pivot point and helically rotating forwards around and under the runner of a ski vehicle to a position below said pivot point.

3. An emergency ski brake system as in claim 1 wherein then second ski runner has a pivot point for receiving a snowmobile suspension and steering mechanism, and wherein the second unit is located along side of and perpendicular to the suspension spindle and above said pivot point and helically rotating forwards around and under the runner of a ski vehicle to a position below said pivot point.

4. An emergency ski brake system in which the manufacturing process comprises a non left/right-sensitive production method of most parts so as to aid in cost reduction and provide interchangeability between units.

5. An emergency ski brake system which comprises a safety tether system to immediately activate said emergency ski braking system in the event of accidental operator dismount.

6. An emergency ski brake system in which is used the existing forces of the terrain passing under the runner during forward movement of the ski vehicle to force the ski brake into place under the runner and to hold it in position until the ski vehicle has stopped at which time the emergency ski brake system can then be reset.

7. An emergency ski brake system which utilizes the existing linear strength of the runner of a ski vehicle to absorb the load acting upon the ski brake when the ski brake system is in use thus allowing the ski brake mechanism to be constructed of lightweight, inexpensive materials.

8. An emergency ski brake system in which the outside position of the blades attached to the helically rotating members on the runners of a ski vehicle, combined with the “leaning” of the runners caused by camber geometry during turning, acts to pivot the ski vehicle around the inside ski brake, therefore adding enhanced turning control.

9. An emergency ski braking system wherein the terrain contacting members are angled back just enough so as to allow “cleaning” of the members but not so much as to allow the terrain contacting members to inadvertently change the direction of the ski vehicle while traveling.
